(19) United States
(12) Patent Application Publication
(10) Pub. No.: US 2023/0323026 A1
(43) Pub. Date: Oct. 12, 2023

(54) POLYCARBONATE RESIN COMPOSITION AND MOLDED ITEM THEREOF

(71) Applicant: IDEMITSU KOSAN CO.,LTD., Tokyo (JP)

(72) Inventors: Yuichi YAMASHITA, Chiba-shi, Chiba (JP); Nobuhiro WATANABE, Chiba-shi, Chiba (JP)

(73) Assignee: IDEMITSU KOSAN CO.,LTD., Tokyo (JP)

(21) Appl. No.: 18/018,513

(22) PCT Filed: Jul. 30, 2021
(86) PCT No.: PCT/JP2021/028313

§ 371 Date: Jan. 27, 2023

(30) Foreign Application Priority Data
Jul. 31, 2020 (JP) 2020-131214

(51) Int. Cl. C08G 64/24; C08G 64/18; C08L 25/08; C08K 5/103; C08L 51/00; C08L 23/08

(52) U.S. Cl. CPC C08G 64/186; C08G 64/24; C08K 5/103; C08L 23/0853; C08L 25/08; C08L 51/00; C08G 2261/126; C08G 2261/228; C08G 2261/592; C08G 2261/596; C08G 2261/62; C08L 2203/20

(57) ABSTRACT

The present invention provides a polycarbonate-based resin composition, including: a polycarbonate-based resin (S) containing a polycarbonate-polyorganosiloxane copolymer (A), which contains a polycarbonate block (A-1) formed of a specific repeating unit and a polyorganosiloxane block (A-2) containing a specific repeating unit; and a copolymer (B) including a constituent unit (b-1) having a specific structure, a constituent unit (b-2) having a specific structure, and a constituent unit (b-3) having a specific structure.

### TECHNICAL FIELD

The present invention relates to a polycarbonate-based resin composition and a molded body thereof.

### BACKGROUND ART

A polycarbonate-based resin is excellent in, for example, impact resistance, heat resistance, and transparency, and hence has been used as a material for various parts in, for example, an electrical and electronic field, and an automotive field by taking advantage of these features.

Slidability may be required depending on a place where any such part is used. With regard to this point, for example, a polycarbonate-based resin formed of bisphenol A tends to be poor in slidability when used alone, and hence an attempt has been made to improve the slidability. For example, there has been known a polycarbonate resin composition containing, in a system obtained by blending a polycarbonate resin with a rubber-reinforced styrene-based resin, both of copolymers having specific structures in specific amounts each (PTL 1).

However, when such polycarbonate-based resin composition is used as an automobile member particularly under an environment in an automobile room, there occurs a problem in that its mechanical characteristics such as impact resistance reduce.

A polycarbonate-polyorganosiloxane (hereinafter sometimes abbreviated as “PC-POS”) copolymer has been known as a polycarbonate resin excellent in impact resistance and flame retardancy (see PTL 2).

However, the PC-POS copolymer tends to be inferior in slidability to any other polycarbonate resin, and hence an attempt has been made to improve its slidability. For example, there has been known a polycarbonate-based resin composition including: a polycarbonate-polyorganosiloxane copolymer having a specific structure and a combination of specific chain lengths; and a specific compound (PTL 3). However, the slidability of the composition is susceptible to improvement.

In addition, the PC-POS copolymer tends to be more strongly yellowish than any other polycarbonate resin is, and hence its hue is susceptible to improvement when the copolymer is used in an automobile interior.

### CITATION LIST

### Patent Literature

PTL 1: JP 2018-141078 A
PTL 2: JP 2010-037495 A
PTL 3: JP 2020-7402 A

### SUMMARY OF INVENTION

### Technical Problem

An object of the present invention is to provide a polycarbonate-based resin composition, which is excellent in slidability and impact resistance, and has a satisfactory hue, and a molded body thereof.

### Solution to Problem

The inventors of the present invention have found that a polycarbonate-based resin composition including a polycarbonate-based resin containing a polycarbonate-polyorganosiloxane copolymer having a specific structure and a specific compound has not only excellent slidability and excellent impact resistance but also an excellent hue. The present invention relates to the following items [1] to [8].

A polycarbonate-based resin composition, comprising:
a polycarbonate-based resin (S) containing a polycarbonate-polyorganosiloxane copolymer (A), which contains a polycarbonate block (A-1) formed of a repeating unit represented by the following general formula (I) and a polyorganosiloxane block (A-2) containing a repeating unit represented by the following general formula (II); and
a copolymer (B) including a constituent unit (b-1) represented by the following general formula (X1), a constituent unit (b-2) represented by the following general formula (X2), and a constituent unit (b-3) represented by the following general formula (X3):

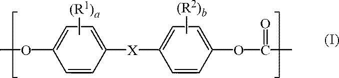

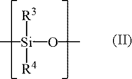

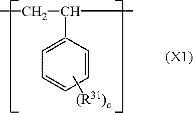

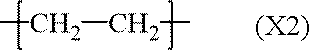

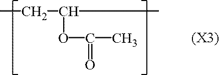

wherein R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, R³ and R⁴ each independently represent a hydrogen atom, a halogen atom, an alkyl group having 1 to 6 carbon atoms, an alkoxy group having 1 to 6 carbon atoms, or an aryl group having 6 to 12 carbon atoms, “a” and “b” each independently represent an integer of from 0 to 4, R³¹s each independently represent a halogen atom or an alkyl group having 1 to 10 carbon atoms, and “c” represents an integer of from 0 to 5.

The polycarbonate-based resin composition according to the above-mentioned item [1], wherein the constituent unit (b-1) represented by the general formula (X1) forms a side chain of the copolymer (B).

The polycarbonate-based resin composition according to the above-mentioned item [1] or [2], wherein the constituent unit (b-2) represented by the general formula (X2) and the constituent unit (b-3) represented by the general formula (X3) form a main chain of the copolymer (B).

The polycarbonate-based resin composition according to any one of the above-mentioned items [1] to [3], wherein a content of the copolymer (B) is from 0.5 part by mass or more to 20 parts by mass or less with respect to 100 parts by mass of the polycarbonate-based resin (S).

The polycarbonate-based resin composition according to any one of the above-mentioned items [1] to [4], further comprising a release agent (C).

The polycarbonate-based resin composition according to the above-mentioned item [5], wherein the release agent (C) is a fatty acid ester.

The polycarbonate-based resin composition according to any one of the above-mentioned items [1] to [6], wherein the polyorganosiloxane block (A-2) in the polycarbonate-polyorganosiloxane copolymer (A) has an average chain length of 50 or more.

A molded body, which is obtained by molding the polycarbonate-based resin composition of any one of the above-mentioned items [1] to [7].

### Advantageous Effects of Invention

According to the present invention, the polycarbonate-based resin composition, which is excellent in slidability and impact resistance, and has a satisfactory hue, and the molded body thereof, can be obtained.

### BRIEF DESCRIPTION OF DRAWINGS

FIG. 1 is an illustration of a schematic view of a friction coefficient evaluation.

FIG. 2 is an illustration of an example of a frictional wear test.

### DESCRIPTION OF EMBODIMENTS

A polycarbonate-based resin composition of the present invention includes: a polycarbonate-based resin (S) containing a polycarbonate-polyorganosiloxane copolymer (A), which contains a polycarbonate block (A-1) formed of a specific repeating unit and a polyorganosiloxane block (A-2) containing a specific repeating unit; and a copolymer (B) including a constituent unit (b-1) represented by the general formula (X1), a constituent unit (b-2) represented by the general formula (X2), and a constituent unit (b-3) represented by the general formula (X3).

The polycarbonate-based resin composition of the present invention, and a molded body thereof are described in detail below. In this description, a specification considered to be preferred may be arbitrarily adopted, and it can be said that a combination of preferred specifications is more preferred. The term “from XX to YY” as used herein means “from XX or more to YY or less.”

### Polycarbonate-based Resin Composition

The polycarbonate-based resin composition of the present invention includes: the polycarbonate-based resin (S) containing the polycarbonate-polyorganosiloxane copolymer (A); and the copolymer (B) including the constituent unit (b-1), the constituent unit (b-2), and the constituent unit (b-3).

### <Polycarbonate-Based Resin (S)>

The polycarbonate-based resin (S) for forming the polycarbonate-based resin composition of the present invention contains the polycarbonate-polyorganosiloxane copolymer (A), which contains the polycarbonate block (A-1) formed of a repeating unit represented by the following general formula (I) and the polyorganosiloxane block (A-2) containing a repeating unit represented by the following general formula (II):

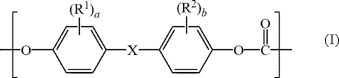

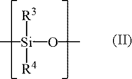

wherein R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, R³ and R⁴ each independently represent a hydrogen atom, a halogen atom, an alkyl group having 1 to 6 carbon atoms, an alkoxy group having 1 to 6 carbon atoms, or an aryl group having 6 to 12 carbon atoms, and “a” and “b” each independently represent an integer of from 0 to 4.

In the general formula (I), examples of the halogen atom that R¹ and R² each independently represent include a fluorine atom, a chlorine atom, a bromine atom, and an iodine atom.

Examples of the alkyl group that R¹ and R² each independently represent include a methyl group, an ethyl group, a n-propyl group, an isopropyl group, various butyl groups (the term “various” means that a linear group and all kinds of branched groups are included, and in this description, the same holds true for the following), various pentyl groups, and various hexyl groups. Examples of the alkoxy group that R¹ and R² each independently represent include alkoxy groups having the above-mentioned alkyl groups as alkyl group moieties.

Examples of the alkylene group represented by X include a methylene group, an ethylene group, a trimethylene group, a tetramethylene group, and a hexamethylene group. Among them, an alkylene group having 1 to 5 carbon atoms is preferred. Examples of the alkylidene group represented by X include an ethylidene group and an isopropylidene group. Examples of the cycloalkylene group represented by X include a cyclopentanediyl group, a cyclohexanediyl group, and a cyclooctanediyl group. Among them, a cycloalkylene group having 5 to 10 carbon atoms is preferred. Examples of the cycloalkylidene group represented by X include a cyclohexylidene group, a 3,5,5-trimethylcyclohexylidene group, and a 2-adamantylidene group. Among them, a cycloalkylidene group having 5 to 10 carbon atoms is preferred, and a cycloalkylidene group having 5 to 8 carbon atoms is more preferred. Examples of the aryl moiety of the arylalkylene group represented by X include aryl groups each having 6 to 14 ring-forming carbon atoms, such as a phenyl group, a naphthyl group, a biphenyl group, and an anthryl group, and examples of the alkylene group include the above-mentioned alkylene groups. Examples of the aryl moiety of the arylalkylidene group represented by X include aryl groups each having 6 to 14 ring-forming carbon atoms, such as a phenyl group, a naphthyl group, a biphenyl group, and an anthryl group, and examples of the alkylidene group may include the above-mentioned alkylidene groups.

“a” and “b” each independently represent an integer of from 0 to 4, preferably from 0 to 2, more preferably 0 or 1.

Among them, a repeating unit in which “a” and “b” each represent 0, and X represents a single bond or an alkylene group having 1 to 8 carbon atoms, or a repeating unit in which “a” and “b” each represent 0, and X represents an alkylene group having 3 carbon atoms, in particular an isopropylidene group is suitable.

In the general formula (II), examples of the halogen atom represented by R³ or R⁴ include a fluorine atom, a chlorine atom, a bromine atom, and an iodine atom. Examples of the alkyl group represented by R³ or R⁴ include a methyl group, an ethyl group, a n-propyl group, an isopropyl group, various butyl groups, various pentyl groups, and various hexyl groups. Examples of the alkoxy group represented by R³ or R⁴ include alkoxy groups having the above-mentioned alkyl groups as alkyl group moieties. Examples of the aryl group represented by R³ or R⁴ include a phenyl group and a naphthyl group.

R³ and R⁴ each preferably represent a hydrogen atom, an alkyl group having 1 to 6 carbon atoms, an alkoxy group having 1 to 6 carbon atoms, or an aryl group having 6 to 12 carbon atoms, and each more preferably represent a methyl group.

More specifically, the polyorganosiloxane block (A-2) containing the repeating unit represented by the general formula (II) preferably has a unit represented by at least any one of the following general formulae (II-I) to (II-III):

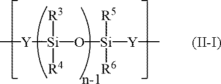

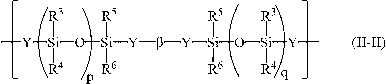

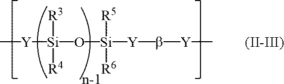

wherein R³ to R⁶ each independently represent a hydrogen atom, a halogen atom, an alkyl group having 1 to 6 carbon atoms, an alkoxy group having 1 to 6 carbon atoms, or an aryl group having 6 to 12 carbon atoms, and a plurality of R³, R⁴, R⁵, or R⁶ may be identical to or different from each other, Y represents —R⁷O—, —R⁷COO—, —R⁷NH—, —R⁷NR⁸—, —COO—, —S—, —R⁷COO—R⁹—O—, or —R⁷O—R¹⁰—O—, and a plurality of Y may be identical to or different from each other, the R⁷ represents a single bond, a linear, branched, or cyclic alkylene group, an aryl-substituted alkylene group, a substituted or unsubstituted arylene group, or a diarylene group, R⁸ represents an alkyl group, an alkenyl group, an aryl group, or an aralkyl group, R⁹ represents a diarylene group, R¹⁰ represents a linear, branched, or cyclic alkylene group, or a diarylene group, β represents a divalent group derived from a diisocyanate compound, or a divalent group derived from a dicarboxylic acid or a halide of a dicarboxylic acid, “n” represents the average chain length of the polyorganosiloxane, and n-1, and “p” and “q” each represent the number of repetitions of a polyorganosiloxane unit and each represent an integer of 1 or more, and the sum of “p” and “q” is n-2.

Examples of the halogen atom that R³ to R⁶ each independently represent include a fluorine atom, a chlorine atom, a bromine atom, and an iodine atom. Examples of the alkyl group that R³ to R⁶ each independently represent include a methyl group, an ethyl group, a n-propyl group, an isopropyl group, various butyl groups, various pentyl groups, and various hexyl groups. Examples of the alkoxy group that R³ to R⁶ each independently represent include alkoxy groups having the above-mentioned alkyl groups as alkyl group moieties. Examples of the aryl group that R³ to R⁶ each independently represent include a phenyl group and a naphthyl group.

R³ to R⁶ each preferably represent a hydrogen atom, an alkyl group having 1 to 6 carbon atoms, an alkoxy group having 1 to 6 carbon atoms, or an aryl group having 6 to 12 carbon atoms.

R³ to R⁶ in the general formula (II-I), the general formula (II-II), and/or the general formula (II-III) each preferably represent a methyl group.

The linear or branched alkylene group represented by R⁷ in —R⁷O—, -R⁷COO-, —R⁷NH—, —R⁷NR⁸—, -R⁷COO-R⁹-O-, or —R⁷O—R¹⁰—O— represented by Y is, for example, an alkylene group having 1 to 8 carbon atoms, preferably 1 to 5 carbon atoms. The cyclic alkylene group represented by R⁷ is, for example, a cycloalkylene group having 5 to 15 carbon atoms, preferably 5 to 10 carbon atoms.

The aryl-substituted alkylene group represented by R⁷ may have a substituent, such as an alkoxy group or an alkyl group, on its aromatic ring, and a specific structure thereof may be, for example, a structure represented by the following general formula (i) or (ii). When R⁷ represents the aryl-substituted alkylene group, the alkylene group is bonded to Si.

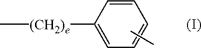

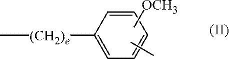

wherein “c” represents a positive integer and typically represents an integer of from 1 to 6.

The diarylene group represented by any one of R⁷, R⁹, and R¹⁰ refers to a group in which two arylene groups are linked to each other directly or through a divalent organic group, and is specifically a group having a structure represented by —Ar¹—W—Ar²—, wherein Ar¹ and Ar² each represent an arylene group, and W represents a single bond or a divalent organic group. The divalent organic group represented by W is, for example, an isopropylidene group, a methylene group, a dimethylene group, or a trimethylene group.

Examples of the arylene group represented by any one of R⁷, Ar¹, and Ar² include arylene groups each having 6 to 14 ring-forming carbon atoms, such as a phenylene group, a naphthylene group, a biphenylene group, and an anthrylene group. Those arylene groups may each have an arbitrary substituent, such as an alkoxy group or an alkyl group.

The alkyl group represented by R⁸ is a linear or branched group having 1 to 8, preferably 1 to 5 carbon atoms. The alkenyl group represented by R⁸ is, for example, a linear or branched group having 2 to 8, preferably 2 to 5 carbon atoms. Examples of the aryl group represented by R⁸ include a phenyl group and a naphthyl group. Examples of the aralkyl group represented by R⁸ include a phenylmethyl group and a phenylethyl group.

The linear, branched, or cyclic alkylene group represented by R¹⁰ is the same as that represented by R⁷.

Y preferably represents —R⁷O—. R⁷ preferably represents an aryl-substituted alkylene group, in particular a residue of a phenol-based compound having an alkyl group, and more preferably represents an organic residue derived from allylphenol or an organic residue derived from eugenol.

With regard to “p” and “q” in the formula (II-II), it is preferred that p=q.

β represents a divalent group derived from a diisocyanate compound, or a divalent group derived from a dicarboxylic acid or a halide of a dicarboxylic acid, and examples thereof include divalent groups represented by the following general formulae (iii) to (vii).

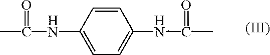

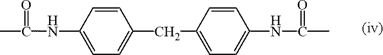

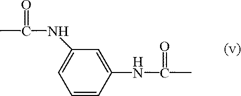

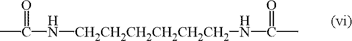

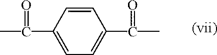

The average chain length “n” of the polyorganosiloxane block (A-2) in the PC-POS copolymer (A) is preferably from 20 or more to 500 or less. The average chain length “n” is the average number of repetitions of the repeating unit represented by the formula (II). “n” in each of the formulae (II-I) and (II-III) is from 20 or more to 500 or less, and in the case of the formula (II-II), a number obtained by adding 2 to the sum of “p” and “q” falls within the range. The average chain length is calculated by nuclear magnetic resonance (NMR) measurement. When the average chain length of the polycarbonate-polyorganosiloxane copolymer (A) is from 20 or more to 500 or less, the polycarbonate-based resin composition to be finally obtained is excellent in impact resistance, slidability, and the like, and can also achieve an excellent hue.

The average chain length of the polyorganosiloxane block (A-2) is more preferably 35 or more, still more preferably 45 or more, still further more preferably 50 or more, particularly preferably 70 or more, and is more preferably 300 or less, still more preferably 150 or less, still further more preferably 100 or less.

The content of the polyorganosiloxane block (A-2) in the PC-POS copolymer (A) is preferably from 0.1 mass% or more to 60 mass% or less. When the amount of the polyorganosiloxane block in the PC-POS copolymer (A) falls within the range, a polycarbonate-based resin composition having more excellent impact resistance, a more excellent transparent hue, and excellent slidability can be obtained. The content of the polyorganosiloxane block (A-2) in the PC-POS copolymer (A) is calculated by nuclear magnetic resonance (NMR) measurement.

The content of the polyorganosiloxane block (A-2) in the PC-POS copolymer (A) is more preferably 2 mass% or more, still more preferably 3 mass% or more, particularly preferably 4 mass% or more, and is more preferably 50 mass% or less, still more preferably 35 mass% or less, still further more preferably 15 mass% or less, particularly preferably 10 mass% or less, most preferably 8 mass% or less.

The content of the polyorganosiloxane block (A-2) in the polycarbonate-based resin composition is preferably from 0.1 mass% or more to 45 mass% or less. When the amount of the polyorganosiloxane block in the PC-POS copolymer (A) falls within the range, a polycarbonate-based resin composition having more excellent impact resistance, a more excellent hue, and excellent slidability can be obtained. The content of the polyorganosiloxane block (A-2) in the polycarbonate-based resin composition is calculated by nuclear magnetic resonance (NMR) measurement as in the content of the polyorganosiloxane block (A-2) in the PC-POS copolymer (A).

The content of the polyorganosiloxane block (A-2) in the polycarbonate-based resin composition is more preferably 2 mass% or more, still more preferably 3 mass% or more, particularly preferably 4 mass% or more, and is more preferably 35 mass% or less, still more preferably 25 mass% or less, particularly preferably 10 mass% or less, most preferably 8 mass% or less.

The viscosity-average molecular weight (Mv) of the PC-POS copolymer (A) may be appropriately adjusted by using, for example, a molecular weight modifier (terminal stopper) so as to be a target molecular weight in accordance with applications or products in which the copolymer is used. The viscosity-average molecular weight of the PC-POS copolymer (A) is preferably from 9,000 or more to 50,000 or less. When the viscosity-average molecular weight is 9,000 or more, a sufficient strength of a molded body can be obtained. When the viscosity-average molecular weight is 50,000 or less, injection molding or extrusion molding can be performed at the temperature at which the heat deterioration of the copolymer does not occur.

The viscosity-average molecular weight of the PC-POS copolymer (A) is more preferably 12,000 or more, still more preferably 14,000 or more, particularly preferably 16,000 or more, and is more preferably 30,000 or less, still more preferably 25,000 or less, still more preferably 23,000 or less, particularly preferably 20,000 or less.

The viscosity-average molecular weight (Mv) is a value calculated from the following Schnell’s equation by measuring the limiting viscosity [η] of a methylene chloride solution at 20° C.

$$\left[\text{η}\right] = 1.23 \times {10}^{- 5} \times M {v}^{0.83}$$

The PC-POS copolymer (A) may be produced by a known production method, such as an interfacial polymerization method (phosgene method), a pyridine method, or an ester exchange method. Particularly when the interfacial polymerization method is adopted, a step of separating an organic phase containing the PC-POS copolymer and an aqueous phase containing an unreacted product, a catalyst residue, or the like becomes easier, and hence the separation of the organic phase containing the PC-POS copolymer and the aqueous phase in each washing step based on, for example, alkali washing, acid washing, or pure water washing becomes easier. Accordingly, the PC-POS copolymer is efficiently obtained. With regard to a method of producing the PC-POS copolymer, reference may be made to, for example, a method described in JP 2014-80462 A.

Specifically, the PC-POS copolymer (A) may be produced by: dissolving a polycarbonate oligomer produced in advance to be described later and a polyorganosiloxane in a water-insoluble organic solvent (e.g., methylene chloride); adding a solution of a dihydric phenol-based compound (e.g., bisphenol A) in an aqueous alkali compound (e.g., aqueous sodium hydroxide) to the solution; and subjecting the mixture to an interfacial polycondensation reaction through use of a tertiary amine (e.g., triethylamine) or a quaternary ammonium salt (e.g., trimethylbenzylammonium chloride) as a polymerization catalyst in the presence of a terminal stopper (a monohydric phenol such as p-tert-butylphenol). In addition, the PC-POS copolymer (A) may also be produced by copolymerizing the polyorganosiloxane and a dihydric phenol, and phosgene, a carbonate ester, or a chloroformate.

A polyorganosiloxane represented by the following general formula (1), general formula (2), and/or general formula (3) may be used as the polyorganosiloxane serving as a raw material:

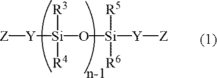

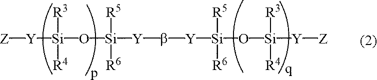

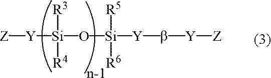

wherein
R³ to R⁶, Y, β, n-1, “p”, and “q” are as described above, and specific examples and preferred examples thereof are also the same as those described above, and
Z represents a hydrogen atom or a halogen atom, and a plurality of Z may be identical to or different from each other.

Examples of the polyorganosiloxane represented by the general formula (1) include compounds each represented by any one of the following general formulae (1-1) to (1-11):

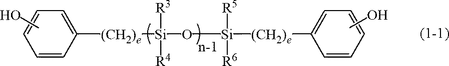

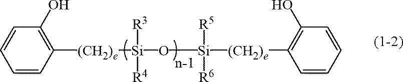

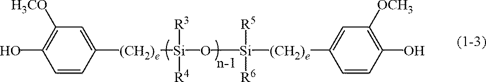

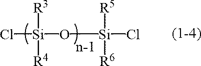

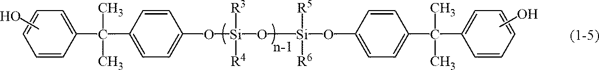

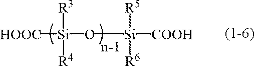

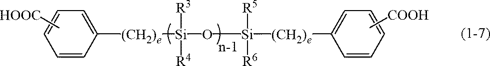

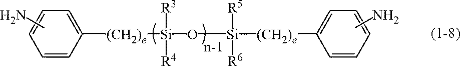

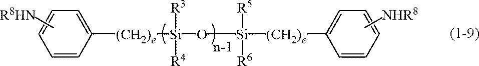

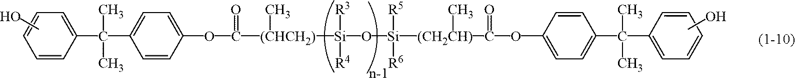

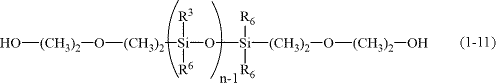

wherein in the general formulae (1-1) to (1-11), R³ to R⁶, n-1, and R⁸ are as defined above, and preferred examples thereof are also the same as those described above, and “c” represents a positive integer and typically represents an integer of from 1 to 6.

Among them, a phenol-modified polyorganosiloxane represented by the general formula (1-1) is preferred from the viewpoint of the ease of the polymerization of the polyorganosiloxane. In addition, an a,ω-bis[3-(o-hydroxyphenyl)propyl]polydimethylsiloxane, which is one compound represented by the general formula (1-2), or an a,ω-bis[3-(4-hydroxy-3-methoxyphenyl)propyl]polydimethylsiloxane, which is one compound represented by the general formula (1-3), is preferred from the viewpoint of its ease of availability.

In addition to the foregoing, a compound having a structure represented by the following general formula (4) may be used as a polyorganosiloxane raw material:

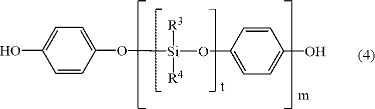

wherein R³ and R⁴ are identical to those described above. The average chain length of the polyorganosiloxane block represented by the general formula (4) is (r×m), and the range of the (r×m) is the same as that of the “n”.

When the compound represented by the general formula (4) is used as a polyorganosiloxane raw material, the polyorganosiloxane block (A-2) preferably has a unit represented by the following general formula (II-IV):

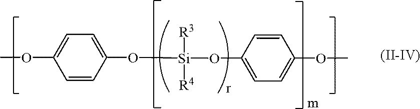

wherein R³, R⁴, “r”, and “m” are as described above.

The copolymer may include a structure represented by the following general formula (II-V) as the polyorganosiloxane block (A-2):

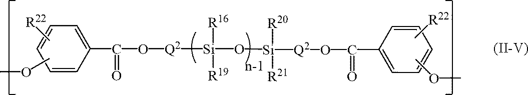

wherein R¹⁸ to R²¹ each independently represent a hydrogen atom or an alkyl group having 1 to 13 carbon atoms, R²² represents an alkyl group having 1 to 6 carbon atoms, a hydrogen atom, a halogen atom, a hydroxy group, an alkoxy group having 1 to 6 carbon atoms, or an aryl group having 6 to 14 carbon atoms, Q² represents a divalent aliphatic group having 1 to 10 carbon atoms, and “n” represents an average chain length and is as described above.

In the general formula (II-V), examples of the alkyl group having 1 to 13 carbon atoms that R¹⁸ to R²¹ each independently represent include a methyl group, an ethyl group, a n-propyl group, an isopropyl group, various butyl groups, various pentyl groups, various hexyl groups, various heptyl groups, various octyl groups, a 2-ethylhexyl group, various nonyl groups, various decyl groups, various undecyl groups, various dodecyl groups, and various tridecyl groups. Among them, R¹⁸ to R²¹ each preferably represent a hydrogen atom or an alkyl group having 1 to 6 carbon atoms, and it is more preferred that all of R¹⁸ to R²¹ each represent a methyl group.

Examples of the alkyl group having 1 to 6 carbon atoms represented by R²² include a methyl group, an ethyl group, a n-propyl group, an isopropyl group, various butyl groups, various pentyl groups, and various hexyl groups. Examples of the halogen atom represented by R²² include a fluorine atom, a chlorine atom, a bromine atom, and an iodine atom. An example of the alkoxy group having 1 to 6 carbon atoms represented by R²² is an alkoxy group whose alkyl group moiety is the alkyl group described above. Examples of the aryl group having 6 to 14 carbon atoms represented by R²² include a phenyl group, a toluyl group, a dimethylphenyl group, and a naphthyl group.

Among them, R²² preferably represents a hydrogen atom or an alkoxy group having 1 to 6 carbon atoms, more preferably represents a hydrogen atom or an alkoxy group having 1 to 3 carbon atoms, and still more preferably represents a hydrogen atom.

The divalent aliphatic group having 1 to 10 carbon atoms represented by Q² is preferably a linear or branched divalent saturated aliphatic group having 1 or more to 10 or less carbon atoms. The number of carbon atoms of the saturated aliphatic group is preferably from 1 or more to 8 or less, more preferably from 2 or more to 6 or less, still more preferably from 3 or more to 6 or less, still further more preferably from 4 or more to 6 or less. In addition, the average chain length “n” is as described above.

A preferred mode of the constituent unit (II-V) may be, for example, a structure represented by the following general formula (II-VI):

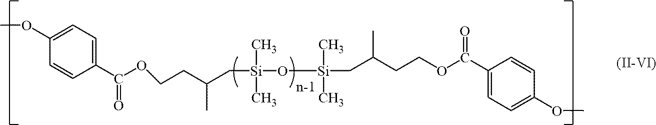

wherein n-1 is as described above.

The polyorganosiloxane block (A-2) represented by the general formula (II-V) or (II-VI) may be obtained by using a polyorganosiloxane raw material represented by the following general formula (5) or (6):

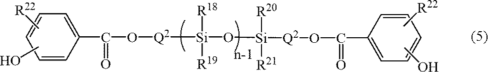

wherein R¹⁸ to R²², Q², and n-1 are as described above;

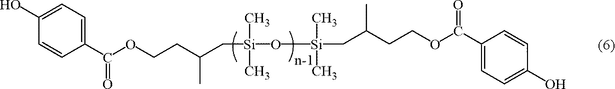

wherein n-1 is as described above.

A method of producing the polyorganosiloxane is not particularly limited. According to, for example, a method described in JP 11-217390 A, a crude polyorganosiloxane may be obtained by: causing cyclotrisiloxane and disiloxane to react with each other in the presence of an acid catalyst to synthesize a,ω-dihydrogen organopentasiloxane; and then subjecting the a,ω-dihydrogen organopentasiloxane to an addition reaction with, for example, a phenolic compound (e.g., 2-allylphenol, 4-allylphenol, eugenol, or 2-propenylphenol) in the presence of a catalyst for a hydrosilylation reaction. In addition, according to a method described in JP 2662310 B2, the crude polyorganosiloxane may be obtained by: causing octamethylcyclotetrasiloxane and tetramethyldisiloxane to react with each other in the presence of sulfuric acid (acid catalyst); and subjecting the resultant a,ω-dihydrogen organopolysiloxane to an addition reaction with the phenolic compound or the like in the presence of the catalyst for a hydrosilylation reaction in the same manner as that described above. The a,ω-dihydrogen organopolysiloxane may be used after its chain length “n” has been appropriately adjusted in accordance with its polymerization conditions, or a commercial a,ω-dihydrogen organopolysiloxane may be used. Specifically, a polyorganosiloxane described in JP 2016-098292 A may be used.

The polycarbonate oligomer may be produced by a reaction between a dihydric phenol and a carbonate precursor, such as phosgene or triphosgene, in an organic solvent, such as methylene chloride, chlorobenzene, or chloroform. When the polycarbonate oligomer is produced by using an ester exchange method, the oligomer may be produced by a reaction between the dihydric phenol and a carbonate precursor such as diphenyl carbonate.

A dihydric phenol represented by the following general formula (viii) is preferably used as the dihydric phenol:

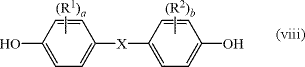

wherein R¹, R², “a”, “b”, and X are as described above.

Examples of the dihydric phenol represented by the general formula (viii) include: bis(hydroxyphenyl)alkane-based dihydric phenols, such as 2,2-bis(4-hydroxyphenyl)propane [bisphenol A], bis(4-hydroxyphenyl)methane, 1,1-bis(4-hydroxyphenyl)ethane, and 2,2-bis(4-hydroxy-3,5-dimethylphenyl)propane; 4,4′-dihydroxydiphenyl; bis(4-hydroxyphenyl)cycloalkanes; bis(4-hydroxyphenyl) oxide; bis(4-hydroxyphenyl) sulfide; bis(4-hydroxyphenyl) sulfone; bis(4-hydroxyphenyl) sulfoxide; and bis(4-hydroxyphenyl) ketone. Those dihydric phenols may be used alone or as a mixture thereof.

Among them, bis(hydroxyphenyl)alkane-based dihydric phenols are preferred, and bisphenol A is more preferred. When bisphenol A is used as the dihydric phenol, the PC-POS copolymer is such that in the general formula (i), X represents an isopropylidene group and a=b=0.

Examples of the dihydric phenol except bisphenol A include bis(hydroxyaryl)alkanes, bis(hydroxyaryl)cycloalkanes, dihydroxyaryl ethers, dihydroxydiaryl sulfides, dihydroxydiaryl sulfoxides, dihydroxydiaryl sulfones, dihydroxydiphenyls, dihydroxydiaryl fluorenes, and dihydroxydiaryl adamantanes. Those dihydric phenols may be used alone or as a mixture thereof.

Examples of the bis(hydroxyaryl)alkanes include bis(4-hydroxyphenyl)methane, 1,1-bis(4-hydroxyphenyl)ethane, 2,2-bis(4-hydroxyphenyl)butane, 2,2-bis(4-hydroxyphenyl)octane, bis(4-hydroxyphenyl)phenylmethane, bis(4-hydroxyphenyl)diphenylmethane, 2,2-bis(4-hydroxy-3-methylphenyl)propane, bis(4-hydroxyphenyl)naphthylmethane, 1,1-bis(4-hydroxy-3-tert-butylphenyl)propane, 2,2-bis(4-hydroxy-3-bromophenyl)propane, 2,2-bis(4-hydroxy-3,5-dimethylphenyl)propane, 2,2-bis(4-hydroxy-3-chlorophenyl)propane, 2,2-bis(4-hydroxy-3,5-dichlorophenyl)propane, and 2,2-bis(4-hydroxy-3,5-dibromophenyl)propane.

Examples of the bis(hydroxyaryl)cycloalkanes include 1,1-bis(4-hydroxyphenyl)cyclopentane, 1,1-bis(4-hydroxyphenyl)cyclohexane, 1,1-bis(4-hydroxyphenyl)-3,5,5-trimethylcyclohexane, 2,2-bis(4-hydroxyphenyl)norbornane, and 1,1-bis(4-hydroxyphenyl)cyclododecane. Examples of the dihydroxyaryl ethers include 4,4′-dihydroxydiphenyl ether and 4,4′-dihydroxy-3,3′-dimethylphenyl ether.

Examples of the dihydroxydiaryl sulfides include 4,4′-dihydroxydiphenyl sulfide and 4,4′-dihydroxy-3,3′-dimethyldiphenyl sulfide. Examples of the dihydroxydiaryl sulfoxides include 4,4′-dihydroxydiphenyl sulfoxide and 4,4′-dihydroxy-3,3′-dimethyldiphenyl sulfoxide. Examples of the dihydroxydiaryl sulfones include 4,4′-dihydroxydiphenyl sulfone and 4,4′-dihydroxy-3,3′-dimethyldiphenyl sulfone.

An example of the dihydroxydiphenyls is 4,4′-dihydroxydiphenyl. Examples of the dihydroxydiarylfluorenes include 9,9-bis(4-hydroxyphenyl)fluorene and 9,9-bis(4-hydroxy-3-methylphenyl)fluorene. Examples of the dihydroxydiaryladamantanes include 1,3-bis(4-hydroxyphenyl)adamantane, 2,2-bis(4-hydroxyphenyl)adamantane, and 1,3-bis(4-hydroxyphenyl)-5,7-dimethyladamantane.

Examples of dihydric phenols except those described above include 4,4′-[1,3-phenylenebis(1-methylethylidene)]bisphenol, 10,10-bis(4-hydroxyphenyl)-9-anthrone, and 1,5-bis(4-hydroxyphenylthio)-2,3-dioxapentane.

In order to adjust the molecular weight of the PC-POS copolymer to be obtained, a terminal stopper (molecular weight modifier) may be used. Examples of the terminal stopper may include monohydric phenols, such as phenol, p-cresol, p-tert-butylphenol, p-tert-octylphenol, p-cumylphenol, p-nonylphenol, m-pentadecylphenol, and p-tert-amylphenol. Those monohydric phenols may be used alone or in combination thereof.

After the interfacial polycondensation reaction, the PC-POS copolymer (A) may be obtained by appropriately leaving the resultant at rest to separate the resultant into an aqueous phase and an organic solvent phase [separating step], washing the organic solvent phase (preferably washing the phase with a basic aqueous solution, an acidic aqueous solution, and water in the stated order) [washing step], concentrating the resultant organic phase [concentrating step], and drying the concentrated phase [drying step].

### <Polycarbonate-Based Resin (A′)>

The polycarbonate-based resin (S) may contain a polycarbonate-based resin (A′) except the PC-POS copolymer (A). The polycarbonate-based resin (A′) is not particularly limited, and various known polycarbonate-based resins may each be used.

The viscosity-average molecular weight (Mv) of the polycarbonate-based resin (A′) is typically from 10,000 to 50,000, preferably from 13,000 to 35,000, more preferably from 14,000 to 28,000, still more preferably from 16,000 to 25,000.

The viscosity-average molecular weight (Mv) is a value calculated from Schnell’s equation as in that of the PC-POS copolymer (A).

Specifically, a resin obtained by a conventional production method for a polycarbonate may be used as the polycarbonate-based resin (A′). Examples of the conventional method include: an interfacial polymerization method involving causing the dihydric phenol-based compound and phosgene to react with each other in the presence of an organic solvent inert to the reaction and an aqueous alkali solution, adding a polymerization catalyst, such as a tertiary amine or a quaternary ammonium salt, to the resultant, and polymerizing the mixture; and a pyridine method involving dissolving the dihydric phenol-based compound in pyridine or a mixed solution of pyridine and an inert solvent, and introducing phosgene to the solution to directly produce the resin. A molecular weight modifier (terminal stopper), a branching agent, or the like is used as required in the reaction.

The dihydric phenol-based compound is, for example, a compound represented by the following general formula (III′):

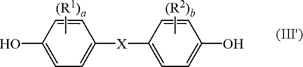

wherein R¹, R², X, “a”, and “b” are as defined above, and preferred examples thereof are also the same as those described above.

Specific examples of the dihydric phenol-based compound may include those described above in the method of producing the polycarbonate-polyorganosiloxane copolymer (A), and preferred examples thereof are also the same as those described above. Among them, bis(hydroxyphenyl)alkane-based dihydric phenols are preferred, and bisphenol A is more preferred.

The polycarbonate-based resins (A′) may be used alone or in combination thereof. The polycarbonate-based resin (A′) is free of such polyorganosiloxane block (A-2) as represented by the formula (II) unlike the polycarbonate-polyorganosiloxane copolymer (A). For example, the polycarbonate-based resin (A′) may be a homopolycarbonate resin, and is preferably an aromatic polycarbonate-based resin.

The polycarbonate-based resin (S) in the polycarbonate-based resin composition of the present invention may be only the PC-POS copolymer (A) described above, or may contain the PC-POS copolymer (A) and the polycarbonate-based resin (A′).

From the viewpoints of the impact resistance and slidability of the molded body of the resin composition, the content of the PC-POS copolymer (A) in the polycarbonate-based resin (S) incorporated into the polycarbonate-based resin composition is preferably 5 mass% or more, more preferably 10 mass% or more, still more preferably 30 mass% or more, still further more preferably 50 mass% or more, still further more preferably 60 mass% or more, still further more preferably 70 mass% or more, still further more preferably 80 mass% or more, still further more preferably 90 mass% or more, particularly preferably 95 mass% or more, most preferably 100 mass% (i.e., the polycarbonate-based resin (S) is free of the polycarbonate-based resin (A′)).

### <Copolymer (B)>

The copolymer (B) incorporated into the polycarbonate-based resin composition of the present invention is a copolymer including the constituent unit (b-1) represented by the following general formula (X1), the constituent unit (b-2) represented by the following general formula (X2), and the constituent unit (b-3) represented by the following general formula (X3):

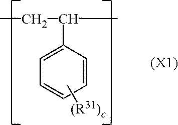

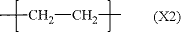

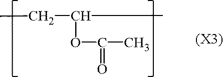

wherein R³¹s each independently represent a halogen atom or an alkyl group having 1 to 10 carbon atoms, and “c” represents an integer of from 0 to 5.

The constituent unit (b-1) is represented by the general formula (X1).

In the general formula (X1), examples of the halogen atom represented by R³¹ include a fluorine atom, a chlorine atom, a bromine atom, and an iodine atom.

Examples of the alkyl group having 1 to 10 carbon atoms represented by R³¹ include a methyl group, an ethyl group, a n-propyl group, an isopropyl group, various butyl groups, various pentyl groups, various hexyl groups, various heptyl groups, various octyl groups, various nonyl groups, and various decyl groups.

“c” represents an integer of from 0 to 5, preferably from 0 to 3, more preferably 0 or 1. It is particularly preferred that c=0.

The constituent unit (b-2) is represented by the general formula (X2). The constituent unit (b-3) is represented by the general formula (X3).

The copolymer (B) is not particularly limited as long as the copolymer includes the constituent unit (b-1) represented by the general formula (X1), the constituent unit (b-2) represented by the general formula (X2), and the constituent unit (b-3) represented by the general formula (X3). The copolymer (B) may be any one of a random copolymer and a block copolymer each including the constituent unit (b-1), the constituent unit (b-2), and the constituent unit (b-3). In addition, the copolymer (B) may be such a copolymer that the three kinds of the constituent unit (b-1), the constituent unit (b-2), and the constituent unit (b-3) form its linear or branched main chain, or such a copolymer that one kind, or each of two kinds, selected from the constituent unit (b-1), the constituent unit (b-2), and the constituent unit (b-3) forms its main chain, and the at least one other kind undergoes polymerization (e.g., graft polymerization) to form a side chain thereof.

From the viewpoints of excellent slidability and an excellent hue, it is preferred that the constituent unit (b-1) form a side chain of the copolymer (B), and/or the constituent unit (b-2) and the constituent unit (b-3) form the main chain of the copolymer (B), and it is more preferred that the constituent unit (b-1) form the side chain of the copolymer (B), and the constituent unit (b-2) and the constituent unit (b-3) form the main chain of the copolymer (B).

For example, the following aspects are given as aspects in the copolymer (B), though the contents of the constituent unit (b-1), the constituent unit (b-2), and the constituent unit (b-3) in the copolymer are not particularly limited.

The content of the constituent unit (b-1) represented by the general formula (X1) is preferably from 10 mass% or more to 50 mass% or less with respect to 100 mass% of the total of the constituent unit (b-2) represented by the general formula (X2) and the constituent unit (b-3) represented by the general formula (X3).

The content of the constituent unit (b-2) represented by the general formula (X2) is preferably from 80 mass% or more to 99 mass% or less, more preferably from 90 mass% or more to 97 mass% or less with respect to 100 mass% of the total of the constituent unit (b-2) represented by the general formula (X2) and the constituent unit (b-3) represented by the general formula (X3).

The content of the constituent unit (b-3) represented by the general formula (X3) is preferably from 1 mass% or more to 20 mass% or less, more preferably from 3 mass% or more to 10 mass% or less with respect to 100 mass% of the total of the constituent unit (b-2) represented by the general formula (X2) and the constituent unit (b-3) represented by the general formula (X3).

### <Ethylene-Vinyl Acetate Copolymer (B′) Including Styrene-Based (Co)Polymer Segment>

An ethylene-vinyl acetate copolymer (B′) including a styrene-based (co)polymer segment is given as a preferred aspect of the copolymer (B). Although the ethylene-vinyl acetate copolymer (B′) including the styrene-based (co)polymer segment is not limited as long as the copolymer is a copolymer formed of the styrene-based (co)polymer segment and an ethylene-vinyl acetate copolymer segment, the copolymer is preferably a graft copolymer formed of the styrene-based (co)polymer segment and the ethylene-vinyl acetate copolymer segment. Further, the copolymer is preferably a graft copolymer including the ethylene-vinyl acetate copolymer segment as its main chain and including the styrene-based (co)polymer segment as a side chain thereof.

### (Styrene-Based (Co)Polymer Segment)

The styrene-based (co)polymer segment includes the constituent unit (b-1) represented by the general formula (X1). The styrene-based (co)polymer segment is a polymer including only the constituent unit (b-1) represented by the general formula (X1), or a copolymer including the constituent unit (b-1) represented by the general formula (X1) and a constituent unit (b-4) represented by the following general formula (X4) or the following general formula (X5):

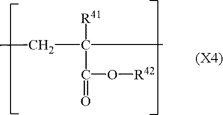

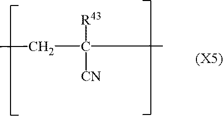

wherein R⁴¹ and R⁴³ each independently represent a hydrogen atom or a methyl group, and R⁴² represents an alkyl group having 1 to 8 carbon atoms or a glycidyl group.

Examples of the alkyl group having 1 to 8 carbon atoms represented by R⁴² in the general formula (X4) include a methyl group, an ethyl group, a n-propyl group, an isopropyl group, various butyl groups, various pentyl groups, various hexyl groups, various heptyl groups, and various octyl groups.

In the general formula (X4), R⁴¹ preferably represents a methyl group. In addition, R⁴² preferably represents a glycidyl group.

In the general formula (X5), R⁴³ preferably represents a methyl group.

Although the contents of the constituent unit (b-1) represented by the general formula (X1) and the constituent unit (b-4) represented by the general formula (X4) or the general formula (X5) in the styrene-based (co)polymer segment are not particularly limited, the content of the constituent unit (b-1) represented by the general formula (X1) is preferably from 50 mass% or more to 100 mass% or less with respect to 100 mass% of the total of the constituent unit (b-1) represented by the general formula (X1) and the constituent unit (b-4) represented by the general formula (X4) or the general formula (X5).

### (Ethylene-Vinyl Acetate Copolymer)

The ethylene-vinyl acetate copolymer is a copolymer including the constituent unit (b-2) represented by the general formula (X2) and the constituent unit (b-3) represented by the general formula (X3). The ethylene-vinyl acetate copolymer may be a random copolymer of ethylene and vinyl acetate, or a block copolymer thereof.

The ratio of the constituent unit (b-3) represented by the general formula (X3) in the ethylene-vinyl acetate copolymer is preferably from 1 mass% to 20 mass%, more preferably from 2 mass% to 15 mass%, still more preferably from 3 mass% to 10 mass% with respect to the total mass of the constituent unit (b-2) represented by the general formula (X2) and the constituent unit (b-3) represented by the general formula (X3).

In a preferred aspect of the ethylene-vinyl acetate copolymer (B′) including the styrene-based (co)polymer segment, the copolymer is a graft copolymer including the ethylene-vinyl acetate copolymer segment as its main chain and including the styrene-based (co)polymer segment as a side chain thereof. The term “main chain” as used herein refers to the longest chain structure moiety in a molecule of the copolymer.

The ethylene-vinyl acetate copolymer (B′) including the styrene-based (co)polymer segment may be produced by any one of various known methods. As a suitable method thereof, there may be given a method involving: mixing an aqueous suspension, which is obtained by adding a suspending agent to the ethylene-vinyl acetate copolymer, with a styrene-based monomer or any further other vinyl-based monomer and a radically polymerizable organic peroxide; heating and stirring the mixture to impregnate the ethylene-vinyl acetate copolymer with the above-mentioned components; and then further increasing the temperature of the resultant to polymerize the components, to thereby produce the copolymer.

In addition, the ethylene-vinyl acetate copolymer (B′) including the styrene-based (co)polymer segment is commercially available, and may be obtained by selecting a product from, for example, a series of products available under the product name “MODIPER” from NOF Corporation. An example thereof is “MODIPER AS100.”

From the viewpoints of excellent slidability and an excellent hue (YI value) of the molded body, the content of the copolymer (B) is preferably from 0.5 part by mass or more to 20 parts by mass or less, more preferably from 1 part by mass or more to 15 parts by mass or less, still more preferably from 2 parts by mass or more to 10 parts by mass or less, still further more preferably from 2 parts by mass or more to 7 parts by mass or less with respect to 100 parts by mass of the polycarbonate-based resin (S).

### <Release Agent (C)>

The polycarbonate-based resin composition of the present invention may further include a release agent (C) from the viewpoint of excellent slidability.

The release agent (C) is, for example, a fatty acid ester. More specifically, the release agent (C) may be preferably, for example, a full ester of pentaerythritol and an aliphatic carboxylic acid. The full ester of pentaerythritol and the aliphatic carboxylic acid is obtained by subjecting pentaerythritol and the aliphatic carboxylic acid to an esterification reaction to provide a full ester.

An aliphatic carboxylic acid having 12 to 30 carbon atoms may be preferably used as the aliphatic carboxylic acid that is a constituent component of the full ester.

Aliphatic carboxylic acids produced from various vegetable oils and fats, and animal oils and fats may each be used as the aliphatic carboxylic acid. Those oils and fats are ester compounds containing various fatty acids as their components. Accordingly, for example, stearic acid produced from the vegetable oils and fats, and the animal oils and fats typically contains a large amount of any other fatty acid component such as palmitic acid. In the present invention, a mixed fatty acid containing a plurality of fatty acids produced from such vegetable oils and fats, and animal oils and fats may be used, or a fatty acid obtained by subjecting the fatty acids to purification and separation may be used.

Among the aliphatic carboxylic acids each having 12 to 30 carbon atoms, an aliphatic carboxylic acid having 12 to 22 carbon atoms is preferred. Among the aliphatic carboxylic acids, a saturated fatty acid is preferably used. In particular, a saturated fatty acid having 12 to 22 carbon atoms is more preferably used. Among the saturated fatty acids each having 12 to 22 carbon atoms, stearic acid, palmitic acid, or behenic acid is preferred.

Preferred specific compounds of the full ester of pentaerythritol and an aliphatic carboxylic acid include a pentaerythritol stearic acid full ester, a pentaerythritol palmitic acid full ester, and a pentaerythritol behenic acid full ester. In particular, a mixture containing the pentaerythritol palmitic acid full ester and the pentaerythritol stearic acid full ester at a mixing ratio of from 9:1 to 1:9, more preferably from 5:5 to 3:7 in terms of mass ratio is preferably used from, for example, the viewpoint of considering compliance with the European REACH standard. For example, the pentaerythritol stearic acid full ester has already been preregistered as an existing substance in REACH because the full ester has heretofore been widely used as a release agent. In contrast, the pentaerythritol palmitic acid full ester needs to be newly preregistered as a novel substance, but cost required for the registration is expensive, and a procedure therefor becomes more complicated. Accordingly, a mixture containing the pentaerythritol stearic acid full ester at such a high composition ratio as to be handleable as the pentaerythritol stearic acid full ester is preferably used. In addition, for example, the following fact is given as a reason why the composition ratio of the pentaerythritol stearic acid full ester is preferably high: the pentaerythritol stearic acid full ester, which has a C18 carbon chain, is more excellent in, for example, releasing performance when turned into a resin composition than the pentaerythritol palmitic acid full ester, which has a C16 carbon chain, is.

The content of the release agent (C) with respect to 100 parts by mass of the polycarbonate-based resin (S) is preferably 0.10 part by mass or more, more preferably 0.15 part by mass or more, still more preferably 0.20 part by mass or more, still further more preferably 0.25 part by mass or more, and is preferably 0.45 part by mass or less, more preferably 0.40 part by mass or less, still more preferably 0.35 part by mass or less, still further more preferably 0.30 part by mass or less.

### <Other Additives>

The polycarbonate-based resin composition of the present invention may be further blended with any other additive to the extent that the effects of the present invention are not impaired. Examples of the other component may include a hydrolysis-resistant agent, an antioxidant, a UV absorber, a flame retardant, a flame retardant aid, a reinforcing material, a filler, an elastomer for an impact resistance improvement, a pigment, and a dye. Some of the components are described in detail.

### <Antioxidant>

The polycarbonate-based resin composition of the present invention preferably further includes the antioxidant. The blending of the polycarbonate-based resin composition with the antioxidant can suppress the oxidative deterioration of the polycarbonate-based resin composition at the time of its melting, and hence can suppress, for example, the coloring thereof due to the oxidative deterioration. For example, a phosphorus-based antioxidant and/or a phenol-based antioxidant is suitably used as the antioxidant.

Examples of the phenol-based antioxidant include hindered phenols, such as n-octadecyl-3-(3,5-di-tert-butyl-4-hydroxyphenyl)propionate, 2,6-di-tert-butyl-4-methylphenol, 2,2′-methylenebis(4-methyl-6-tert-butylphenol), and pentaerythrityl-tetrakis[3-(3,5-di-tert-butyl-4-hydroxyphenyl)propionate].

Among those antioxidants, antioxidants each having a pentaerythritol diphosphite structure, such as bis(2,6-di-tert-butyl-4-methylphenyl)pentaerythritol diphosphite and bis(2,4-di-tert-butylphenyl)pentaerythritol diphosphite, and triphenylphosphine are preferred.

Examples of commercial products of the phenol-based antioxidant may include Irganox 1010 (manufactured by BASF Japan Ltd., trademark), Irganox 1076 (manufactured by BASF Japan Ltd., trademark), Irganox 1330 (manufactured by BASF Japan Ltd., trademark), Irganox 3114 (manufactured by BASF Japan Ltd., trademark), BHT (manufactured by Takeda Pharmaceutical Company Limited, trademark), CYANOX 1790 (manufactured by SOLVAY, trademark), and Sumilizer GA-80 (manufactured by Sumitomo Chemical Company, Limited, trademark).

Examples of the phosphorus-based antioxidant include triphenyl phosphite, diphenyl nonyl phosphite, diphenyl (2-ethylhexyl) phosphite, tris(2,4-di-tert-butylphenyl) phosphite, tris(nonylphenyl) phosphite, diphenyl isooctyl phosphite, 2,2′-methylenebis(4,6-di-tert-butylphenyl)octyl phosphite, diphenyl isodecyl phosphite, diphenyl mono(tridecyl) phosphite, phenyl diisodecyl phosphite, phenyl di(tridecyl) phosphite, tris(2-ethylhexyl) phosphite, tris(isodecyl) phosphite, tris(tridecyl) phosphite, dibutyl hydrogen phosphite, trilauryl trithiophosphite, tetrakis(2,4-di-tert-butylphenyl)-4,4′-biphenylene diphosphonite, 4,4′-isopropylidenediphenol dodecyl phosphite, 4,4′-isopropylidenediphenol tridecyl phosphite, 4,4′-isopropylidenediphenol tetradecyl phosphite, 4,4′-isopropylidenediphenol pentadecyl phosphite, 4,4′-butylidenebis(3-methyl-6-tert-butylphenyl)ditridecyl phosphite, bis(2,4-di-tert-butylphenyl)pentaerythritol diphosphite, bis(2,6-di-tert-butyl-4-methylphenyl)pentaerythritol diphosphite, bis(nonylphenyl)pentaerythritol diphosphite, distearyl-pentaerythritol diphosphite, phenyl bisphenol A pentaerythritol diphosphite, tetraphenyl dipropylene glycol diphosphite, 1,1,3-tris(2-methyl-4-di-tridecylphosphite-5-tert-butylphenyl)butane, 3,4,5,6-dibenzo-1,2-oxaphosphane, triphenylphosphine, diphenylbutylphosphine, diphenyloctadecylphosphine, tris(p-tolyl)phosphine, tris(p-nonylphenyl)phosphine, tris(naphthyl)phosphine, diphenyl(hydroxymethyl)phosphine, diphenyl(acetoxymethyl)phosphine, diphenyl (β-ethylcarboxyethyl)phosphine, tris(p-chlorophenyl)phosphine, tris(p-fluorophenyl)phosphine, benzyldiphenylphosphine, diphenyl(β-cyanoethyl)phosphine, diphenyl(p-hydroxyphenyl)phosphine, diphenyl(1,4-dihydroxyphenyl)-2-phosphine, and phenylnaphthylbenzylphosphine.

Examples of commercial products of the phosphorus-based antioxidant may include Irgafos 168 (manufactured by BASF Japan Ltd., trademark), Irgafos 12 (manufactured by BASF Japan Ltd., trademark), Irgafos 38 (manufactured by BASF Japan Ltd., trademark), ADK STAB 2112 (manufactured by ADEKA Corporation, trademark), ADK STAB C (manufactured by ADEKA Corporation, trademark), ADK STAB 329K (manufactured by ADEKA Corporation, trademark), ADK STAB PEP36 manufactured by ADEKA Corporation, trademark), JC-263 (manufactured by Johoku Chemical Co., Ltd., trademark), Sandstab P-EPQ (manufactured by Clariant, trademark), and Doverphos S-9228PC (manufactured by Dover Chemical, trademark).

The above-mentioned antioxidants may be used alone or in combination thereof. The blending amount of the antioxidant in the polycarbonate-based resin composition of the present invention is preferably from 0.001 part by mass or more to 0.5 part by mass or less, more preferably from 0.01 part by mass or more to 0.3 part by mass or less, still more preferably from 0.05 part by mass or more to 0.3 part by mass or less with respect to 100 parts by mass of the polycarbonate-based resin (S). When the amount of the antioxidant with respect to 100 parts by mass of the polycarbonate-based resin (S) falls within the ranges, a sufficient antioxidant action is obtained, and mold contamination at the time of the molding of the resin composition can be suppressed.

When the polycarbonate-based resin composition of the present invention has the above-mentioned composition, the composition can have all of excellent slidability and excellent impact resistance, and an excellent hue.

The term “slidability” means the manner in which a contact portion and/or a movable portion of an article smoothly moves. The slidability may be evaluated by, for example, a dynamic friction coefficient or a static friction coefficient.

The term “satisfactory hue” as used herein means that the yellowish tinge of the polycarbonate-based resin composition is reduced. The hue may be evaluated by, for example, a YI value.

In one aspect of the polycarbonate-based resin composition of the present invention, the total content of the polycarbonate-based resin (S) and the copolymer (B) is preferably from 80 mass% or more to 100 mass% or less, more preferably from 95 mass% or more to 100 mass% or less, still more preferably from 97 mass% or more to 100 mass% or less, still further more preferably from 98 mass% or more to 100 mass% or less, particularly preferably from 99 mass% or more to 100 mass% or less with respect to 100 mass% of the total amount of the polycarbonate-based resin composition.

In another aspect of the polycarbonate-based resin composition of the present invention, the total content of the polycarbonate-based resin (S) and the copolymer (B), and the above-mentioned other components is preferably from 90 mass% or more to 100 mass% or less, more preferably from 95 mass% or more to 100 mass% or less, still more preferably from 97 mass% or more to 100 mass% or less, still further more preferably from 98 mass% or more to 100 mass% or less, particularly preferably from 99 mass% or more to 100 mass% or less with respect to 100 mass% of the total amount of the polycarbonate-based resin composition.

In the polycarbonate-based resin composition of the present invention, the content of the polycarbonate-based resin (S) is preferably from 65 mass% or more to 99.5 mass% or less, more preferably from 80 mass% or more to 99 mass% or less, still more preferably from 85 mass% or more to 98 mass% or less, still further more preferably from 90 mass% or more to 98 mass% or less with respect to 100 mass% of the total amount of the polycarbonate-based resin composition.

In the polycarbonate-based resin composition of the present invention, the content of the PC-POS copolymer (A) is preferably from 20 mass% or more to 99.5 mass% or less, more preferably from 40 mass% or more to 99 mass% or less, still more preferably from 60 mass% or more to 98 mass% or less, still further more preferably from 80 mass% or more to 98 mass% or less with respect to 100 mass% of the total amount of the polycarbonate-based resin composition.

In the polycarbonate-based resin composition of the present invention, the content of the copolymer (B) is preferably from 0.4 mass% or more to 20 mass% or less, more preferably from 1 mass% or more to 15 mass% or less, still more preferably from 1.5 mass% or more to 10 mass% or less, still further more preferably from 2 mass% or more to 10 mass% or less with respect to 100 mass% of the total amount of the polycarbonate-based resin composition.

### Method of Producing Polycarbonate-Based Resin Composition

The polycarbonate-based resin composition of the present invention is obtained by: blending the above-mentioned respective components at the above-mentioned ratios and various optional components to be used as required at appropriate ratios; and kneading the components.

The blending and the kneading may be performed by a method involving premixing with a typically used apparatus, such as a ribbon blender or a drum tumbler, and using, for example, a Henschel mixer, a Banbury mixer, a single-screw extruder, a twin-screw extruder, a multi-screw extruder, or a co-kneader. In normal cases, a heating temperature at the time of the kneading is appropriately selected from the range of from 240° C. or more to 320° C. or less. An extruder, in particular a vented extruder is preferably used in the melt-kneading.

### Molded Body

Various molded bodies may each be produced by an injection molding method, an injection compression molding method, an extrusion molding method, a blow molding method, a press molding method, a vacuum molding method, an expansion molding method, or the like using as a raw material the melt-kneaded polycarbonate-based resin composition of the present invention or a pellet obtained through the melt-kneading. In particular, the pellet obtained through the melt-kneading can be suitably used in the production of injection-molded bodies by injection molding and injection compression molding.

The molded body formed of the polycarbonate-based resin composition of the present invention can be suitably used in, for example, exterior and internal parts for parts for electrical and electronic equipment, such as a television, a radio, a camera, a video camera, an audio player, a DVD player, an air conditioner, a cellular phone, a smartphone, a transceiver, a display, a computer, a tablet terminal, portable game equipment, stationary game equipment, wearable electronic equipment, a register, an electronic calculator, a copying machine, a printer, a facsimile, a communication base station, a battery, or a robot, exterior and internal parts for an automobile, a railway vehicle, a ship, an aircraft, equipment for space industry, or medical equipment, and a part for a building material.

### EXAMPLES

The present invention is more specifically described by way of Examples. However, the present invention is by no means limited by these Examples. In each of Examples, characteristic values and evaluation results were determined in the following manner.

### Chain Length and Content of Polydimethylsiloxane

The chain length and content of a polydimethylsiloxane were calculated by NMR measurement from the integrated value ratio of a methyl group of the polydimethylsiloxane.

In this description, the polydimethylsiloxane is sometimes abbreviated as PDMS.

### <Quantification Method for Chain Length of Polydimethylsiloxane>

¹H-NMR Measurement Conditions
NMR apparatus: ECA-500 manufactured by JEOL Resonance Co., Ltd.
Probe: 50TH5AT/FG2
Observed range: -5 ppm to 15 ppm
Observation center: 5 ppm
Pulse repetition time: 9 sec
Pulse width: 45°
NMR sample tube: 5 φ
Sample amount: 30 mg to 40 mg
Solvent: deuterochloroform
Measurement temperature: room temperature
Number of scans: 256 times

Allylphenol-terminated Polydimethylsiloxane
A: an integrated value of a methyl group in a dimethylsiloxane moiety observed around δ -0.02 to δ 0.5
B: an integrated value of a methylene group in allylphenol observed around δ 2.50 to δ 2.75
Chain length of polydimethylsiloxane=(A/6)/(B/4) Eugenol-terminated Polydimethylsiloxane
A: an integrated value of a methyl group in a dimethylsiloxane moiety observed around δ -0.02 to δ 0.5
B: an integrated value of a methylene group in eugenol observed around δ 2.40 to δ 2.70
Chain length of polydimethylsiloxane=(A/6)/(B/4)

### <Quantification Method for Content of Polydimethylsiloxane>

Quantification method for the copolymerization amount of a polydimethylsiloxane in a PTBP-terminated polycarbonate obtained by copolymerizing an allylphenol-terminated polydimethylsiloxane.
NMR apparatus: ECA-500 manufactured by JEOL Resonance Co., Ltd.
Probe: 50TH5AT/FG2
Observed range: -5 ppm to 15 ppm
Observation center: 5 ppm
Pulse repetition time: 9 sec
Pulse width: 45°
Number of scans: 256 times
NMR sample tube: 5 φ
Sample amount: 30 mg to 40 mg
Solvent: deuterochloroform
Measurement temperature: room temperature
A: an integrated value of a methyl group in a BPA moiety observed around δ 1.5 to δ 1.9
B: an integrated value of a methyl group in a dimethylsiloxane moiety observed around δ -0.02 to δ 0.3
C: an integrated value of a butyl group in a p-tert-butylphenyl moiety observed around δ 1.2 to δ 1.4
a=A/6
b=B/6
c=C/9
T=a+ b+c
f=a/T×100
g=b/T×100
h=c/T×100
TW=f×254+g×74.1+h×149
PDMS (mass%)=g×74.⅟TW×100

### Viscosity-Average Molecular Weight

A viscosity-average molecular weight (Mv) was calculated from the following equation (Schnell’s equation) by using a limiting viscosity [η] determined through the measurement of the viscosity of a methylene chloride solution at 20° C. with an Ubbelohde-type viscometer.

$$\left[\text{η}\right] = 1.23 \times {10}^{- 5} \times M {v}^{0.83}$$

### Friction Coefficient Evaluation

In a friction coefficient evaluation, a static friction coefficient between test pieces was evaluated by an inclination method involving calculating the static friction coefficient from the angle at which an upper test piece started to slide when the inclination angle of an inclined plate was gradually increased with a sliding inclination angle-measuring machine (manufactured by Toyo Seiki Seisaku-sho, Ltd., AN). The test pieces were subjected to the test after having been held under an environment having the following measurement conditions for 24 hours or more.

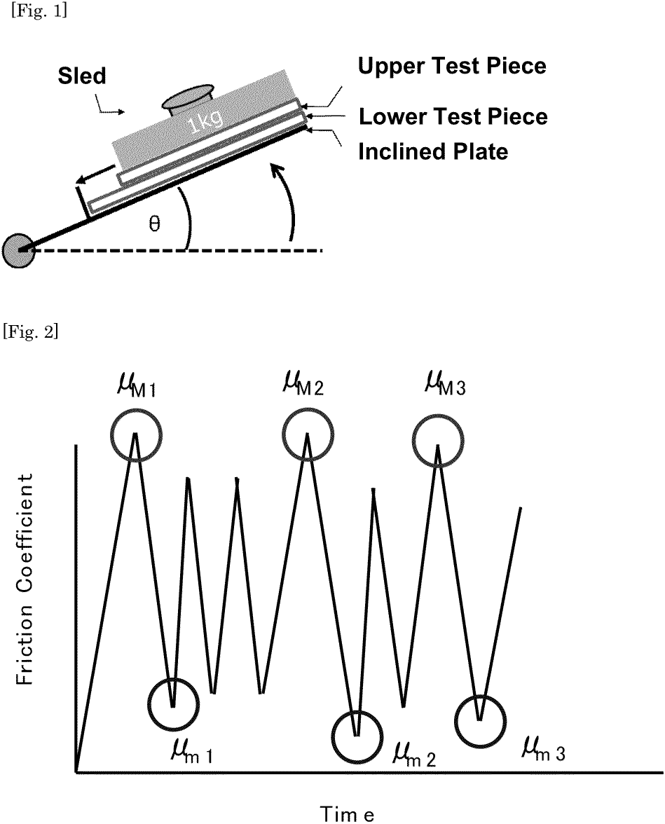

A schematic view of the friction coefficient evaluation is illustrated in FIG. 1. Two sites on both the side surfaces of the test pieces were fixed as follows: the upper test piece was fixed to a dead weight (sled) with a double-sided tape (manufactured by Sumitomo 3M Limited, TRANSPARENT DOUBLE-SIDED TAPE Cat. No. 665-3-12), and the lower test piece was fixed to the inclined plate with the tape. In addition, the orientation of each of the test pieces was set to be a machine direction (MD). The inclination angle θ of the inclined plate when the sliding distance of the upper test piece reached 10 mm was measured.

$${μ}_{S} = tan θ$$

In this evaluation, a result calculated by substituting the measured value of the θ into the above-mentioned equation (Morin’s law) was defined as a static friction coefficient µs. As the value of the static friction coefficient becomes smaller, friction between the test pieces becomes smaller, and hence a polycarbonate-based resin composition for forming the test pieces is more excellent in slidability.

The static friction coefficient was measured five times, and the average of the measured values was determined.

### [Measurement Conditions]

Upper test piece shape: 70 mm long by 100 mm wide by 3.0 mm thick
Lower test piece: The same material (common material), 150 mm long by 150 mm wide by 3.0 mm thick
Rate at which the inclination angle of the inclined plate is changed: 2.7°/s
Sled sectional area: 65 cm² (i.e., a face-to-face pressure is 15 g/cm²)
Sled weight: 1.0 kg
Measurement direction: MD
Number of times of measurement: Five times
Measurement temperature: 23° C.±1° C., relative humidity: 50%±5%
Measurement condition: No lubrication

### Frictional Wear Evaluation

An evaluation was performed with a constant-load measuring machine (HEIDON TYPE-40, manufactured by Shinto Scientific Co., Ltd.). An upper strip test piece was fixed to a vise jig so that its surface cut with a gate cutter (manufactured by Dumbbell Co., Ltd.) became a surface in contact with a lower flat-plate test piece. The lower flat-plate test piece was fixed to the machine side, and then both the test pieces were placed so as to be perpendicular to each other.

In a return path at the time of the 200th reciprocating sliding of the upper strip test piece, the local maximum values of a friction coefficient between the test pieces in the range of from 240.5 (seconds) to 241 (seconds) were represented by µ_{M1}, _{µM2}, and µ_{M3}, respectively in decreasing order, and local minimum values immediately after the µ_{M1}, the µ_{M2}, and the µ_{M3} were represented by µₘ₁, µₘ₂, and µₘ₃, respectively. An example is illustrated in FIG. 2.

The maximum friction coefficient µ_{M} and a difference Δµ were calculated from the following equations. Results obtained by rounding the calculated values to two decimal places are shown in Table 3.

Maximum friction coefficient µ_{M}=(µ_{M1}+µ_{M2}+µ_{M3})/3
Friction coefficient µₘ after stick slipping=(µₘ₁+µₘ₂+µₘ₃)/3
Δµ=µ_{M}-µₘ

### [Measurement Conditions]

Upper strip test piece shape: 40 mm long by 10 mm wide by 4.0 mm thick
Lower flat-plate test piece shape: The same material (common material), 80 mm long by 80 mm wide by 3.0 mm thick
Load condition: 500 g
Measurement speed: 500 mm/min
Measurement length: 10 mm
Number of times of reciprocation: 200 times

### Abnormal Noise Evaluation

The occurrence of abnormal noise during the performance of the above-mentioned frictional wear test was measured with a sound level meter (DT-805L, manufactured by Shenzhen Everbest Machinery Industry Co., Ltd.). The sound level meter fixed to a clamp with a pedestal was brought close to a position distant from the strip test piece fixed to the upper vise jig by 10 mm to perform the measurement. The maximum sound volume (dB) during the measurement is shown as a result.

### [Measurement Conditions]

Response speed: FAST
Range: Low

### (6) Performance Evaluation

### <Impact Resistance Evaluation>

### (Charpy Impact Strength)

A test piece in conformity with JIS K 7139:2009 was produced from a 4-millimeter thick molded body molded out of each of evaluation pellets obtained in Examples, Comparative Examples, and Reference Examples under the following conditions in conformity with JIS K 6719-2:2011. The Charpy impact strengths of the produced test piece at temperatures of 23° C. and -40° C. were measured in conformity with JIS K 7111-1:2012.

### (Molding Conditions)

Pellet drying: 120° C., 5 hours
Injection molding machine: EC100SX (manufactured by Toshiba Machine Co., Ltd.)
Cylinder temperature: 280° C.
Test piece shape: 80 mm±2 mm long by 10 mm±0.2 mm wide

### <Hue Evaluation>

### (YI Value)

A flat plate-shaped test piece measuring 50 mm by 30 mm by 3 mm thick was molded out of each of the evaluation pellets obtained in Examples, Comparative Examples, and Reference Examples with an injection molding machine (manufactured by Niigata Machine Techno Co., Ltd., MD50XB) by an injection molding method at a cylinder temperature of 280° C. and a mold temperature of 80° C. for a cycle time of 40 seconds.

The YI value of the resultant test piece was measured with a spectrophotometer by a reflection method under the conditions of a C light source, a two-degree field of view, and a measurement hole of 30 mmφ five times, and the average of the measured values was determined.

In each of Examples 1 to 6, Comparative Examples 1 to 3, and Reference Examples 1 to 3, SE 2000 (manufactured by Nippon Denshoku Industries Co., Ltd.) was used as the spectrophotometer. In each of Examples 7 to 11 and Comparative Examples 4 to 6, SE 7700 (manufactured by Nippon Denshoku Industries Co., Ltd.) was used as the spectrophotometer.

### <Production Example 1: Production of Polycarbonate Oligomer>

Sodium dithionite was added in an amount of 2,000 ppm with respect to bisphenol A (BPA) (to be dissolved later) to 5.6 mass% aqueous sodium hydroxide, and then BPA was dissolved in the mixture so that the concentration of BPA was 13.5 mass%. Thus, a solution of BPA in aqueous sodium hydroxide was prepared.

The solution of BPA in aqueous sodium hydroxide, methylene chloride, and phosgene were continuously passed through a tubular reactor having an inner diameter of 6 mm and a tube length of 30 m at flow rates of 40 L/hr, 15 L/hr, and 4.0 kg/hr, respectively. The tubular reactor had a jacket portion and the temperature of the reaction liquid was kept at 40° C. or less by passing cooling water through the jacket. The reaction liquid that had exited the tubular reactor was continuously introduced into a baffled vessel-type reactor provided with a sweptback blade and having an internal volume of 40 L. The solution of BPA in aqueous sodium hydroxide, 25 mass% aqueous sodium hydroxide, water, and a 1 mass% aqueous solution of triethylamine were further added to the reactor at flow rates of 2.8 L/hr, 0.07 L/hr, 17 L/hr, and 0.64 L/hr, respectively, to perform a reaction. An aqueous phase was separated and removed by continuously taking out the reaction liquid overflowing the vessel-type reactor and leaving the reaction liquid at rest. Then, a methylene chloride phase was collected.

The polycarbonate oligomer thus obtained had a concentration of 341 g/L and a chloroformate group concentration of 0.71 mol/L.

### <Polycarbonate-Polyorganosiloxane Copolymer (A1)>

15 L of the polycarbonate oligomer solution produced in Production Example 1 described above, 10.1 L of methylene chloride, 407 g of an o-allylphenol terminal-modified polydimethylsiloxane (PDMS) in which the average chain length “n” of a polydimethylsiloxane was 37, and 8.4 mL of triethylamine were loaded into a 50-liter vessel-type reactor including a baffle board, a paddle-type stirring blade, and a cooling jacket. 1,065 g of aqueous sodium hydroxide prepared by dissolving 85 g of sodium hydroxide in 980 mL of pure water was added to the mixture under stirring to perform a reaction between the polycarbonate oligomer and the o-allylphenol terminal-modified PDMS for 20 minutes.

A solution of p-tert-butylphenol (PTBP) in methylene chloride (prepared by dissolving 147 g of PTBP in 1.0 L of methylene chloride) and a solution of bisphenol A in aqueous sodium hydroxide (prepared by dissolving 1,093 g of bisphenol A in an aqueous solution prepared by dissolving 618 g of sodium hydroxide and 2.1 g of sodium dithionite in 9.0 L of pure water) were added to the polymerization liquid to perform a polymerization reaction for 40 minutes.

13 L of methylene chloride was added to the resultant for dilution and the mixture was stirred for 20 minutes. After that, the mixture was separated into an organic phase containing a polycarbonate-polydimethylsiloxane copolymer (PC-PDMS copolymer), and an aqueous phase containing excess amounts of bisphenol A and sodium hydroxide, and the organic phase was isolated.

The solution of the PC-PDMS copolymer in methylene chloride thus obtained was sequentially washed with 0.03 mol/L aqueous sodium hydroxide and 0.2 mol/L hydrochloric acid in amounts of 15 vol% each with respect to the solution. Next, the solution was repeatedly washed with pure water until an electric conductivity in an aqueous phase after the washing became 5 µS/cm or less.

The solution of the PC-PDMS copolymer in methylene chloride obtained by the washing was concentrated and pulverized, and the resultant flake was dried under reduced pressure at 120° C. Thus, a PC-PDMS copolymer (A1) was produced.

The resultant PC-PDMS copolymer (A1) had a PDMS block moiety content determined by NMR of 6.0 mass% and a viscosity-average molecular weight Mv of 17,700.

### <Polycarbonate-Polyorganosiloxane Copolymer (A2)>

A PC-PDMS copolymer (A2) was produced in the same manner as in the polycarbonate-polyorganosiloxane copolymer (A1) except that an o-allylphenol terminal-modified PDMS in which the average chain length “n” of a polydimethylsiloxane was 88 was used.

The resultant PC-PDMS copolymer (A2) had a PDMS block moiety content determined by nuclear magnetic resonance (NMR) of 6.0 mass% and a viscosity-average molecular weight Mv of 17,700.

### <Polycarbonate-Based Resin (A′)>

Aromatic homopolycarbonate resin [manufactured by Idemitsu Kosan Co., Ltd., TARFLON FN1700 (product name), viscosity-average molecular weight=17,700]

### <Copolymer (B)>

“MODIPER AS 100 (product name)” [manufactured by NOF Corporation]

### <Release Agent (C)>

Mixture of a pentaerythritol stearic acid full ester and a pentaerythritol palmitic acid full ester (mixing ratio is C16:C18=1:1.1) [manufactured by Riken Vitamin Co., Ltd., EW440A]

### <Other Components>

Antioxidant: “IRGAFOS 168 (product name)” [tris(2,4-di-tert-butylphenyl) phosphite, manufactured by BASF Japan Ltd.]

### Examples 1 to 6, Comparative Examples 1 to 3, and Reference Examples 1 to 3

The above-mentioned PC-POS copolymer (A1) or (A2), the ethylene-vinyl acetate copolymer (B) including a styrene-based (co)polymer segment, the release agent (C), and the antioxidant were mixed at blending ratios shown in each of Table 1 and Table 2, and the mixture was supplied to a vented twin-screw extruder (manufactured by Toshiba Machine Co., Ltd., TEM-35B), and was melt-kneaded at a screw revolution number of 250 rpm, an ejection amount of 25 kg/hr, and a resin temperature of 280° C. to provide an evaluation pellet sample.

The evaluation pellet sample was dried at 120° C. for 5 hours, and was then subjected to injection molding with an injection molding machine (manufactured by Toshiba Machine Co., Ltd., IS150E-5A) at a cylinder temperature of 280° C. and a mold temperature of 80° C. to produce two flat-plate test pieces (each measuring 150 mm long by 150 mm wide by 3 mm thick) to be used in the friction coefficient evaluation. One of the test pieces was used as the lower test piece. The other test piece was then machined with a contour machine (manufactured by YS Koki Co., Ltd., Vz-300), and burrs on its machined surface were removed with sandpaper. Thus, the upper test piece (measuring 70 mm long by 100 mm wide by 3 mm thick) was produced.

The evaluation results of the friction coefficient tests, impact characteristics, and hues of the evaluation pellet samples are shown in Table 1 and Table 2.

TABLE 1-1

| | | Unit | Reference Example 1 | Reference Example 2 | Reference Example 3 |
|---|---|---|---|---|---|
| PC resin (A′) | FN1700 | Part(s) by mass | 100 | - | - |
| PC-POS copolymer (A) | (A1) n=37 | Part(s) by mass | - | 100 | - |
| | (A2) n=88 | Part(s) by mass | - | - | 100 |
| Ethylene-vinyl acetate copolymer (B) | AS100 | Part(s) by mass | - | - | - |
| Release agent (C) | EW440A | Part(s) by mass | 0.3 | 0.3 | 0.3 |
| Antioxidant | Irg.168 | Part(s) by mass | 0.1 | 0.1 | 0.1 |
| Friction coefficient test | | - | 0.32 | 0.36 | 0.39 |
| Impact characteristic | Charpy (23° C.) | kJ/m² | 15 | 35 | 62 |
| | Charpy (-40° C.) | | 10 | 13 | 28 |
| Hue | YI (reflection method) | % | 2.5 | 6.7 | 13.9 |

TABLE 2

| | | Unit | Comparative Example 1 | Example 1 | Example 2 | Comparative Example 2 | Example 3 | Example 4 | Comparative Example 3 | Example 5 | Example 6 |
|---|---|---|---|---|---|---|---|---|---|---|---|
| PC resin (A′) | FN1700 | Part(s) by mass | 100 | - | - | 100 | - | - | 100 | - | - |
| PC-POS copolymer (A) | (A1) n=37 | Part(s) by mass | - | 100 | - | - | 100 | - | - | 100 | - |
| | (A2) n=88 | Part(s) by mass | - | - | 100 | - | - | 100 | - | - | 100 |
| Ethylene-vinyl acetate copolymer (B) | AS100 | Part(s) by mass | 3 | 3 | 3 | 5 | 5 | 5 | 11 | 11 | 11 |
| Release agent (C) | EW440A | Part(s) by mass | 0.3 | 0.3 | 0.3 | 0.3 | 0.3 | 0.3 | 0.3 | 0.3 | 0.3 |
| Antioxidant | Irg.168 | Part(s) by mass | 0.1 | 0.1 | 0.1 | 0.1 | 0.1 | 0.1 | 0.1 | 0.1 | 0.1 |
| Friction coefficient test | | - | 0.32 | 0.27 | 0.23 | 0.27 | 0.22 | 0.17 | 0.25 | 0.23 | 0.21 |
| Impact characteristic | Charpy (23° C.) | kJ/m² | 19 | 56 | 62 | 28 | 50 | 56 | 26 | 39 | 40 |
| | Charpy (-40° C.) | | 10 | 15 | 24 | 11 | 15 | 22 | 11 | 14 | 18 |
| Hue | YI (reflection method) | % | 0.9 | 0.3 | 0.3 | 1.6 | 1.3 | 1.1 | 1.9 | 1.5 | 1.6 |

### Examples 7 to 11 and Comparative Examples 4 to 7

The above-mentioned PC-POS copolymer (A1) or (A2), the ethylene-vinyl acetate copolymer (B) including a styrene-based (co)polymer segment, the release agent (C), and the antioxidant were mixed at blending ratios shown in Table 3, and the mixture was supplied to a vented twin-screw extruder (manufactured by Toshiba Machine Co., Ltd., TEM-35B), and was melt-kneaded at a screw revolution number of 250 rpm, an ejection amount of 25 kg/hr, and a resin temperature of 280° C. to provide an evaluation pellet sample.

The evaluation pellet sample was dried at 120° C. for 5 hours, and was then subjected to injection molding with an injection molding machine (manufactured by Toshiba Machine Co., Ltd., EC100SX) at a cylinder temperature of 280° C. and a mold temperature of 80° C. to produce a dumbbell-shaped tensile test piece (type A) in conformity with JIS K 7139:2009 and ISO 20753:2008. Then, the test piece was cut into a strip shape (measuring 80 mm long by 10 mm wide by 4 mm thick) with a gate cutter (manufactured by Dumbbell Co., Ltd.) set to 88° C., and was cut in half with a contour machine (manufactured by YS Koki Co., Ltd., Vz-300), followed by the removal of burrs on its surface cut with the gate cutter with a razor or the like. Thus, a strip test piece (measuring 40 mm long by 10 mm wide by 4 mm thick) to be used as the upper test piece of the frictional wear evaluation was produced.

In addition, the above-mentioned evaluation pellet sample was dried at 120° C. for 5 hours, and was then subjected to injection molding with an injection molding machine (manufactured by Nissei Plastic Industrial Co., Ltd., NEX110) at a cylinder temperature of 280° C. and a mold temperature of 80° C. to produce a flat-plate test piece (measuring 80 mm long by 80 mm wide by 3 mm thick) to be used as the lower test piece of the frictional wear evaluation.

Examples 7 to 11 and Comparative Examples 4 to 7 were performed independently of Examples 1 to 6, Comparative Examples 1 to 3, and Reference Examples 1 to 3 described above.

The evaluation results of the frictional wear evaluations, abnormal noise evaluations, impact characteristics, and hues of the evaluation pellet samples are shown in Table 3.

TABLE 3

| | | Unit | Comparative Example 4 | Comparative Example 5 | Example 7 | Example 8 | Example 9 | Comparative Example 6 | Example 10 | Comparative Example 7 | Example 11 |
|---|---|---|---|---|---|---|---|---|---|---|---|
| PC resin (A′) | FN1700 | Part(s) by mass | - | - | - | - | - | 100 | 50 | - | - |
| PC-POS copolymer (A) | (A1) n=37 | Part(s) by mass | - | - | - | - | - | - | - | 100 | 100 |
| | (A2) n=88 | Part(s) by mass | 100 | 100 | 100 | 100 | 100 | - | 50 | - | |
| Ethylene -vinyl acetate copolymer (B) | AS100 | Part(s) by mass | - | - | 2 | 5 | 10 | 5 | 5 | - | 5 |
| Release agent (C) | EW440A | Part(s) by mass | - | 0.3 | 0.3 | 0.3 | 0.3 | 0.3 | 0.3 | 0.3 | 0.3 |
| Antioxidant | Irg.168 | Part(s) by mass | 0.1 | 0.1 | 0.1 | 0.1 | 0.1 | 0.1 | 0.1 | 0.1 | 0.1 |
| Frictional wear evaluation | Maximum friction coefficient | - | 0.98 | 0.55 | 0.37 | 0.31 | 0.33 | 0.38 | 0.35 | 0.74 | 0.35 |
| | Δµ | - | 1.01 | 0.86 | <0.01 | 0.01 | <0.01 | 0.02 | <0.01 | 0.89 | <0.01 |
| Abnormal noise evaluation | Sound level meter | dB | 75 | 77 | 55 | 53 | 51 | 55 | 51 | 76 | 52 |
| Impact characteristic | Charpy (23° C.) Charpy (-30° C.) | kJ/m 2 | 6652 | 6249 | 6450 | 5626 | 4620 | 2811 | 6120 | 3514 | 5017 |
| Hue | YI (reflection method) | - | 12.8 | 13.3 | -2.5 | -0.7 | 0.3 | 0.3 | 0.3 | 5.2 | -0.1 |

### INDUSTRIAL APPLICABILITY

According to the present invention, there can be obtained the polycarbonate-based resin composition, which is improved in slidability and is excellent in hue without impairment of excellent impact resistance of its polycarbonate-based resin, and the molded body thereof. The molded body obtained by the present invention is excellent in slidability, and hence can suppress, for example, squeak noise.

1. A polycarbonate-based resin composition, comprising:
a polycarbonate-based resin (S) containing a polycarbonate-polyorganosiloxane copolymer (A), which contains a polycarbonate block (A-1) formed of a repeating unit represented by the following general formula (I) and a polyorganosiloxane block (A-2) containing a repeating unit represented by the following general formula (II); and
a copolymer (B) including a constituent unit (b-1) represented by the following general formula (X1), a constituent unit (b-2) represented by the following general formula (X2), and a constituent unit (b-3) represented by the following general formula (X3): 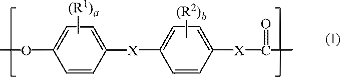 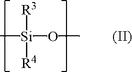 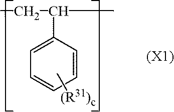 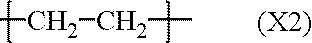 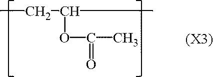
wherein R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, R³ and R⁴ each independently represent a hydrogen atom, a halogen atom, an alkyl group having 1 to 6 carbon atoms, an alkoxy group having 1 to 6 carbon atoms, or an aryl group having 6 to 12 carbon atoms, “a” and “b” each independently represent an integer of from 0 to 4, R³¹s each independently represent a halogen atom or an alkyl group having 1 to 10 carbon atoms, and “c” represents an integer of from 0 to 5.

2. The polycarbonate-based resin composition according to claim 1, wherein the constituent unit (b-1) represented by the general formula (X1) forms a side chain of the copolymer (B).

3. The polycarbonate-based resin composition according to claim 1, wherein the constituent unit (b-2) represented by the general formula (X2) and the constituent unit (b-3) represented by the general formula (X3) form a main chain of the copolymer (B).

4. The polycarbonate-based resin composition according to claim 1, wherein a content of the copolymer (B) is from 0.5 part by mass or more to 20 parts by mass or less with respect to 100 parts by mass of the polycarbonate-based resin (S).

5. The polycarbonate-based resin composition according to claim 1, further comprising a release agent (C).

6. The polycarbonate-based resin composition according to claim 5, wherein the release agent (C) is a fatty acid ester.

7. The polycarbonate-based resin composition according to claim 1, wherein the polyorganosiloxane block (A-2) in the polycarbonate-polyorganosiloxane copolymer (A) has an average chain length of 50 or more.

8. A molded body, which is obtained by molding the polycarbonate-based resin composition of claim 1.
